(19) United States
(12) Patent Application Publication
(10) Pub. No.: US 2011/0068765 A1
(43) Pub. Date: Mar. 24, 2011

(54) SYSTEM AND METHOD FOR POWER CALIBRATING A PULSE GENERATOR

(75) Inventor: Anthony F. Segoria, San Diego, CA (US)

(73) Assignee: QUALCOMM Incorporated, San Diego, CA (US)

(21) Appl. No.: 12/564,248

(22) Filed: Sep. 22, 2009

(51) Int. Cl. G05F 3/16

(52) U.S. Cl. 323/313

(57) ABSTRACT

An apparatus is disclosed for generating an output signal (e.g., a defined pulse), including a power or current calibration feature. The apparatus comprises a current source adapted to generate a first current to produce the output signal, a current sampling module adapted to generate a second current as a function of (e.g., substantially proportional or equal to) the first current, a reference current module (e.g., a bandgap current source) adapted to generate a third current, and a calibration module adapted to calibrate the first current based on the second and third currents. The current source comprises a plurality of selectable current paths. The current sampling module comprises a replica of at least a portion of one or more current paths of the current source. The calibration module may perform a calibration in response to a defined time, an environment parameter (temperature, voltage, pulse repetition frequency, amplitude requirement change, etc.), or the output signal not being generated.

### FIELD

The present disclosure relates generally to communication systems, and more specifically, to a system and method for calibrating the power of a transmit signal, such as a defined pulse signal.

### BACKGROUND

In communication systems, signals are often transmitted from a communication device to a remote communication device via a wireless or free space medium. These communication devices typically employ a transmitter for transmitting signals long distances via the wireless medium. In many cases, the transmitter is operated continuously, whether or not signals are being transmitted. In some cases, operating a transmitter in a continuous manner may be acceptable. However, when the power source is limited, this may not be desirable since the transmitter may not be able to be operated continuously for a long time.

For instance, many communication devices are portable devices, such as cellular telephones, personal digital assistants (PDAs), handheld devices, and other portable communication devices. These portable communication devices typically rely on a limited power source, such as a battery, to perform the various intended operations. A limited power source typically has a continuous use lifetime that depends on the amount of power used by the portable device. It is generally desirable to extend the continuous use lifetime as much as possible. Accordingly, portable communication devices are more frequently designed to consume less and less power.

One technique for operating a transmitter in a more power efficient manner is to use pulse-based modulation techniques (e.g., pulse-position modulation) to transmit signals. In such a system, a transmitter may be operated in a relatively high power consumption mode during the transmission of a pulse signal. However, when the transmitter is not being used to transmit the pulse signal, it is operated in a relatively low power consumption mode in order to conserve power. The power of the pulse signal over time may fluctuate based on a number of factors, including environment parameter changes. For many applications, this may not be desirable.

### SUMMARY

An aspect of the disclosure relates to an apparatus for generating an output signal. The apparatus comprises a current source adapted to generate a first current to produce the output signal, a current sampling module adapted to generate a second current as a function of the first current, a reference current module adapted to generate a third current, and a calibration module adapted to calibrate the first current based on the second and third currents. In another aspect, the second current is substantially proportional or equal to the first current. In yet another aspect, the reference current module comprises a bandgap current source.

In another aspect of the disclosure, the current source comprises a plurality of selectable current paths. In another aspect, the current sampling module comprises a replica of at least a portion of one or more current paths of the current source. In yet another aspect, the selectable current paths are adapted to produce binary-weighted currents, substantially the same currents, or other defined currents.

In another aspect of the disclosure, the first current is based on a signal that defines the amplitude of the first current, and another signal that defines the timing of the amplitude change of the first current. In another aspect, the signal generating apparatus comprises an impedance element through which the first current flows to generate the output signal. In yet another aspect, the output signal comprises a defined pulse. In still another aspect, the calibration module is adapted to calibrate the first current in response to a defined time, an environment parameter, and/or the output signal not being generated. In another aspect, the environment parameter comprises an environment temperature, a power supply voltage, a pulse repetition frequency (PRF), a change in a pulse amplitude requirement.

In another aspect of the disclosure, other aspects, advantages and novel features of the present disclosure will become apparent from the following detailed description of the disclosure when considered in conjunction with the accompanying drawings.

### BRIEF DESCRIPTION OF THE DRAWINGS

FIG. 1 illustrates a block diagram of an exemplary apparatus for generating a pulse signal including a current or power calibration feature in accordance with an aspect of the disclosure.

FIG. 2 illustrates a block diagram of another exemplary apparatus for generating a pulse signal including a current or power calibration feature in accordance with another aspect of the disclosure.

FIG. 3 illustrates a graph of an exemplary pulse signal in accordance with another aspect of the disclosure.

FIG. 4 illustrates a block diagram of another exemplary apparatus for generating a pulse signal including a current or power calibration feature in accordance with another aspect of the disclosure.

FIG. 5 illustrates a flow diagram of an exemplary method of calibrating the current or power of a pulse signal generator in accordance with another aspect of the disclosure.

FIG. 6 illustrates a flow diagram of another exemplary method of calibrating the current or power of a pulse signal generator in accordance with another aspect of the disclosure.

FIG. 7 illustrates a block diagram of an exemplary transceiver in accordance with another aspect of the disclosure.

FIG. 8 illustrates a block diagram of an exemplary transmitter in accordance with another aspect of the disclosure.

FIGS. 9A-D illustrate timing diagrams of various pulse modulation techniques in accordance with another aspect of the disclosure.

FIG. 10 illustrates a block diagram of various communication devices communicating with each other via various channels in accordance with another aspect of the disclosure.

### DETAILED DESCRIPTION

Various aspects of the disclosure are described below. It should be apparent that the teachings herein may be embodied in a wide variety of forms and that any specific structure, function, or both being disclosed herein are merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

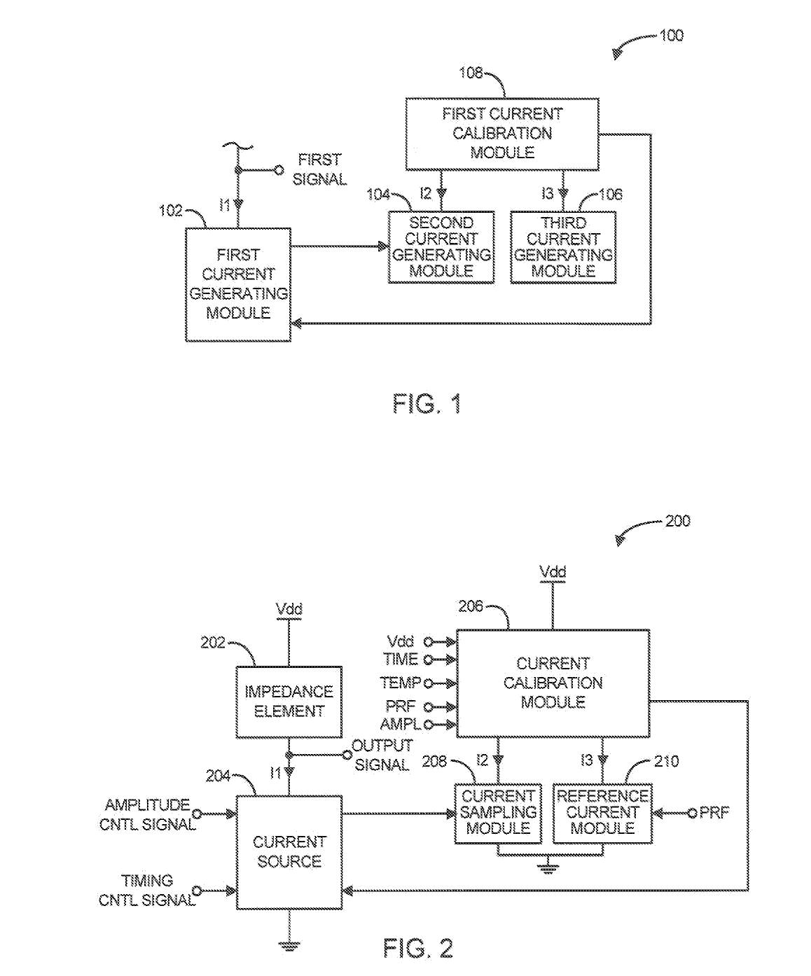

FIG. 1 illustrates a block diagram of an exemplary apparatus 100 for generating a first signal (e.g., a defined pulse) including a current or power calibration feature in accordance with an aspect of the disclosure. In summary, the apparatus 100 includes a first current generating module for generating a first current I1 from which a pulse signal or other type of signal may be produced. Additionally, the apparatus 100 includes a first current calibration module for calibrating the first current I1 in order to control the power level of the first signal and/or for other purposes.

In particular, the apparatus 100 comprises a first current generating module 102, a second current generating module 104, a third current generating module 106, and a first current calibration module 108. The first current generating module 102 is adapted to generate a first current I1 from which a first signal may be produced. The first signal may include a defined pulse signal or other type of signal. The second current generating module 104 is adapted to generate a second current I2 as a function of the first current I1. As an example, the second current I2 may be substantially proportional or substantially equal to the first current I1.

The apparatus 100 further comprises a third current generating module 106 adapted to generate a third current I3. As an example, the third current generating module 106 may be configured as a bandgap current source configured to generate a substantially stable third current I3 with process and temperature variations. Additionally, the apparatus 100 comprises a first current calibration module 108 adapted to calibrate the first current I1 based on the second 12 and the third current I3.

As an example, the first current calibration module 108 may be configured as a current comparator adapted to generate a control signal as a function of the difference between the currents I2 and I3. In a feedback manner, the first current generating module 102 responds to the control signal generated by the first current calibration module 108 by adjusting the first current I1 so that the currents I2 and I3 are substantially the same. This ensures that the first current I1 is at least from time-to-time calibrated with reference to the substantially stable third current I3. Since the first current I1 is related to the power of the first signal, the first current calibration module 108 ensures that the power of the first signal is regulated on a time and/or other basis.

FIG. 2 illustrates a block diagram of another exemplary apparatus 200 for generating a pulse signal including a current or power calibration feature in accordance with another aspect of the disclosure. In summary, the apparatus 200 incorporates the power or current calibration technique discussed above. The apparatus 200 further includes additional features to further assist in the generation and power level calibration of the output signal.

More specifically, the apparatus 200 comprises an impedance element 202, a current source 204, a current calibration module 206, a current sampling module 208, and a reference current module 210. The impedance element 202 and the current source 204 are coupled in series between a positive power supply rail Vdd and a negative power supply rail, which may be at ground potential as shown or a potential more negative than the positive power supply rail Vdd. The current source 204 generates a current I1 in response to an amplitude control signal and a timing control signal. The amplitude control signal defines the amplitude of the current I1 and the timing control signal defines the timing of the amplitude change of the current I1. The current I1 flows through the impedance element 202 to generate the output signal at a node between the impedance element and the current source. The impedance element 202 may be configured as a resonator (e.g., an RLC tank) and/or impedance matching network.

For power or current calibration purposes and/or other purposes, the current sampling module 208 generates a current I2 that substantially varies as a function of the current I1 produced by the current source 204. As previously discussed, the current I2 may be substantially proportional or substantially the same as the current I1. The reference current module 210 generates a reference current I3. For example, the reference current module 210 may be configured as a bandgap current source to generate a substantially stable current with process and temperature variation.

The current calibration module 206 is coupled in series respectively with the current sampling module 208 and the reference current module 210 between the positive power supply rail Vdd and the negative power supply rail (e.g., ground). The current calibration module 206 generates a control signal for calibrating the current I1 generated by the current source 204 based on the currents I2 and I3. As an example, the current calibration module 206 may be configured as a current comparator adapted to generate the control signal as a function of the difference between the currents I2 and I3. The current source 204 responds to the control signal generated by the current calibration module 206 by adjusting the current I1 so that the currents I2 and I3 are substantially the same. This provides for calibration of the current I1, and ultimately, the calibration of the power of the output signal.

Further, in this example, the current calibration module 206 further includes an input to receive one or more signals that may prompt the module to perform a calibration procedure. For example, the current calibration module 206 includes inputs to receive a signal indicative of the power supply voltage (e.g., Vdd) that supplies power to the current source 204, a signal indicative of time, a signal indicative of the environment temperature, a signal indicative of the pulse repetition frequency (PRF) of the output signal, and a signal indicative of the output signal amplitude requirement. The current calibration module 206 may perform a current calibration procedure based on the supply voltage indicating signal. Alternatively, or in addition to, the current calibration module 206 may perform a current calibration procedure based on a defined time as indicated by the time indicating signal. Alternatively, or in addition to, the current calibration module 206 may perform a current calibration procedure in response to an environment temperature change that exceeds a defined threshold as indicated by the temperature signal. Alternatively, or in addition to, the current calibration module 206 may perform a current calibration procedure in response to a change in the PRF that exceeds a defined threshold as indicated by the PRF-indicating signal. Alternatively, or in addition to, the current calibration module 206 may perform a current calibration procedure in response to a change in the output signal amplitude requirement as indicated by the amplitude requirement indicating signal.

Additionally, with regard to the PRF, it may be desirable to change the power of the output signal as a function of the PRF. For example, it may be desirable to change the power of the output signal inversely with the PRF. So, if the PRF increases, it may be desirable to reduce the power of the output signal. Conversely, if the PRF decreases, it may be desirable to increase the power of the output signal. In this regard, the reference current module 210 includes an input to receive a signal indicative of the PRF. In responds to this signal, the reference current module 210 may change the reference current I3 inversely with a change in the PRF as indicated by the PRF signal. Through a calibration procedure, the current I1 tracks the reference current I3. Thus, in this manner, the current I1, and ultimately the power of the output signal, may be controlled to vary inversely with the PRF.

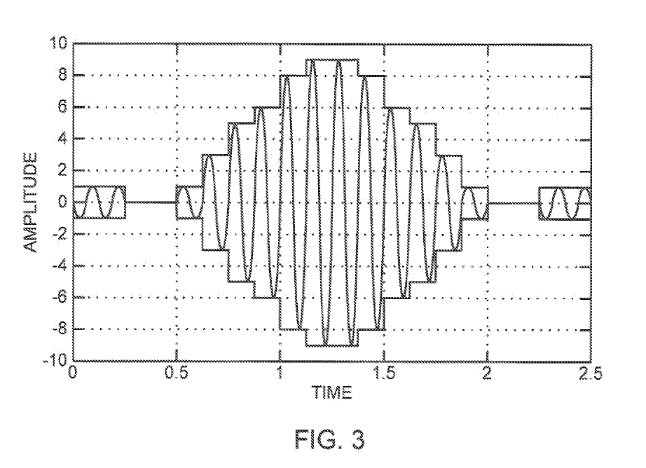

FIG. 3 illustrates a graph of an exemplary pulse signal in accordance with another aspect of the disclosure. The vertical or y-axis of the graph represents the amplitude of the signal, and the horizontal or x-axis represents time. As noted, in this example, the amplitude control signal defines the amplitude of the pulse in steps. For instance, within time interval 0.5 to 0.625, the amplitude of the pulse is varying between ±1, which, in this example, marks the beginning of the pulse. Within time interval 0.625 to 0.75, the amplitude of the pulse is varying between ±3. The amplitude of the pulse continues to rise until it reaches a maximum of ±9 at time interval 1.125 to 1.375. Then, the amplitude decreases in steps until it returns back to an amplitude varying between ±1 at time interval 1.825 to 2.0, which marks the end of the pulse. Although, in this example, the amplitude of the pulse is controlled in steps, it shall be understood that it may be controlled in a continuous fashion.

Also, as noted in the graph, the timing control signal defines when the change in the amplitude of the pulse occurs. In this example, the change in the amplitude occurs substantially at phase zero (0) of a substantially sinewave signal serving as the timing control signal. For instance, in this example, the amplitude of the pulse changed from ±1 to ±3 at substantially phase zero (0) of the sinewave at approximately time 0.625. Similarly, the amplitude of the pulse changed from ±3 to ±5 at substantially phase zero (0) of the sinewave at approximately time 0.75. Likewise, the amplitude of the pulse changed from ±5 to ±6 at substantially phase zero (0) of the sinewave at approximately time 0.875, and so on. It shall be understood that the timing control signal may initiate the change in the amplitude at other phases or in other manners.

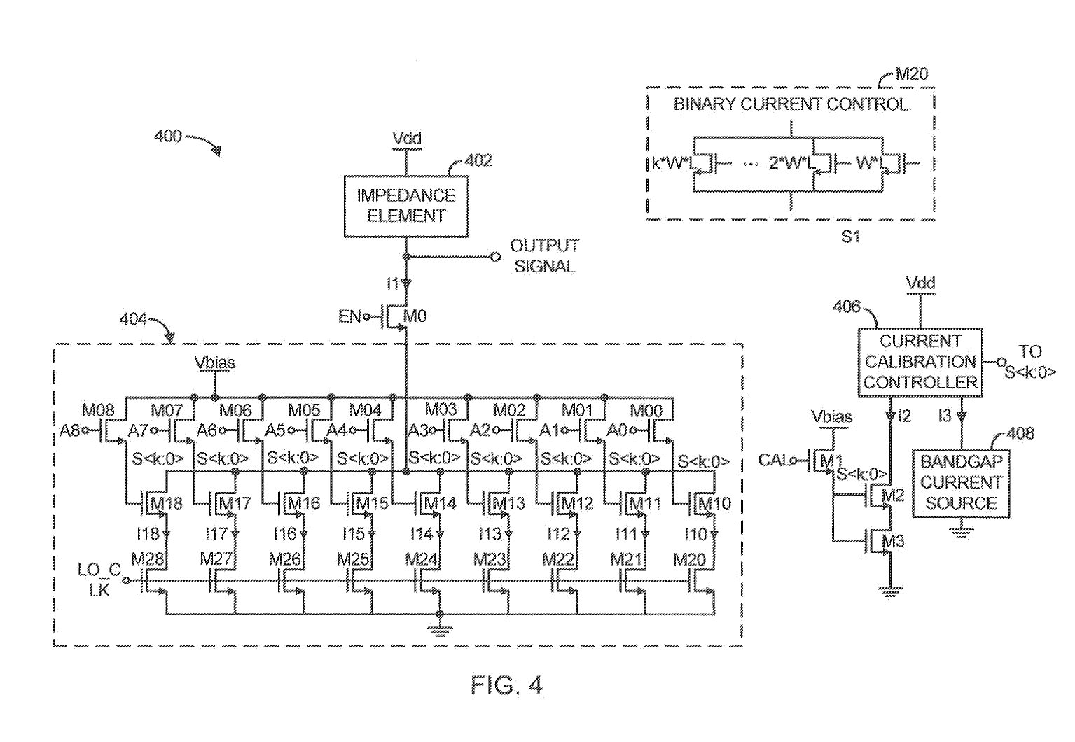

FIG. 4 illustrates a block diagram of another exemplary apparatus 400 for generating a signal including a power calibration feature in accordance with another aspect of the disclosure. The apparatus 400 provides a more detailed exemplary implementation of the signal generating apparatuses with current or power calibration feature previously discussed. In particular, the apparatus 400 comprises an impedance element 402, a switching element M0, and a current source 404. Additionally, for current or power calibration purposes, the apparatus 400 comprises a current calibration controller 406, a calibration enable device M1, a replica current path including devices M2-M3, and a bandgap current source 408.

The impedance element 402, switching element M0, and current source 404 may be connected in series between a positive power supply rail Vdd and a negative power supply rail (e.g., ground). The impedance element 402, in turn, may be a resonator, such as an RLC tank configured to have a resonant frequency at or approximate the center of the frequency spectrum of the output signal. The switching element M0, in turn, may be configured as a metal oxide semiconductor field effect transistor (MOSFET) with a gate adapted to receive an enable (EN) signal, a drain coupled to the impedance element 402, and a source coupled to the current source 404. The output signal may be generated at a node between the current source 404 and the impedance element 402. The current source 404, in turn, comprises a plurality of selectable current paths for generating currents I10 to I18. The current paths comprise series-connected current controlling devices M10-M18 and signal timing control devices M20-M28, respectively. Additionally, the current source 404 comprises current path selecting devices M00-M08 for enabling the current paths 110 to 118, respectively.

More specifically, the gates of the MOSFETs M00-M08 are adapted to receive the amplitude control signal bits A0-A8, respectively. The drains of the MOSFETs M00-M08 are adapted to receive a defined bias voltage Vbias. The sources of MOSFETs M00-M08 are coupled to the enable input of the current controlling devices M10-M18, respectively. Each current controlling device may be configured as a binary current control including a plurality of MOSFETs coupled in parallel, wherein each MOSFET is configured to have a different size k (e.g., wherein W is the channel width and L is the channel length). The size of each current controlling device is controlled by a signal S<k:0> generated by the current calibration controller 406. The drains of the current controlling devices M10-M18 are coupled to the source of MOSFET M0. The sources of the current controlling devices M10-M18 are coupled to the drains of MOSFET M20-M28, respectively. The gates of MOSFETs M20-M28 are adapted to receive the timing control signal LO_CLK. The sources of MOSFETs M20-M28 are coupled to the negative power supply rail (e.g., ground).

With regard to current or power calibration, the replica current path 12 substantially replicates at least one of the current paths of the current source 404. That is, the device M2 is configured substantially the same as a current controlling device (M10-M18) of the current source 404, and receives the control signal S<k:0> from the current calibration controller 406 for controlling its size. Similarly, the device M3 is configured substantially the same as one of the timing controlling device (M20-M28) of the current source 404. Thus, the current I2 generated by the replica current path varies as a function of (e.g., substantially proportional or equal to) the current flowing through a current path of the current source 404. The calibration enable MOSFET M1 includes a gate to receive a calibration enable signal CAL, a drain adapted to receive a defined bias voltage Vbias, and a source coupled to the enable inputs of the replica current path devices M2 and M3. The current calibration controller 406 and replica current path M2-M3 are coupled in series between the positive power supply rail Vdd and the negative power supply rail (e.g., ground). Similarly, the current calibration controller 406 is coupled in series with the bandgap current source 408 between the positive power supply rail Vdd and the negative power supply rail (e.g., ground). The bandgap current source 408 generates a substantially stable current I3 with process and temperature variation.

The process of generating the output signal is as follows. From a previous current calibration procedure, the current controlling signal S<k:0> has been set to control the amount of current through the current controlling devices M10-M18. An initial word of the amplitude control signal A0-A10 is selected in order to set the initial current I1 through the current source 404 by turning on one or more of current controlling devices M10-M18. The timing control signal LO_CLK, which may be an oscillating signal, is applied to the gates of MOSFETs M20-M28 in order to periodically turn on these devices in accordance with the frequency of the signal LO_CLK. Then, the enable signal (EN) is set to turn on MOSFET M0. This electrically couples the impedance element 402 to the current source 404 to form the initial current I1, which is set by how many of the current paths are turned on. For the next cycle of the timing control signal LO_CLK, a new word of the amplitude control signal A0-A10 is selected to turn on a different number of the current controlling devices M10-M18 so as to change the amplitude of the current I1. This process continues until the completion of the desired output signal (e.g., a define pulse).

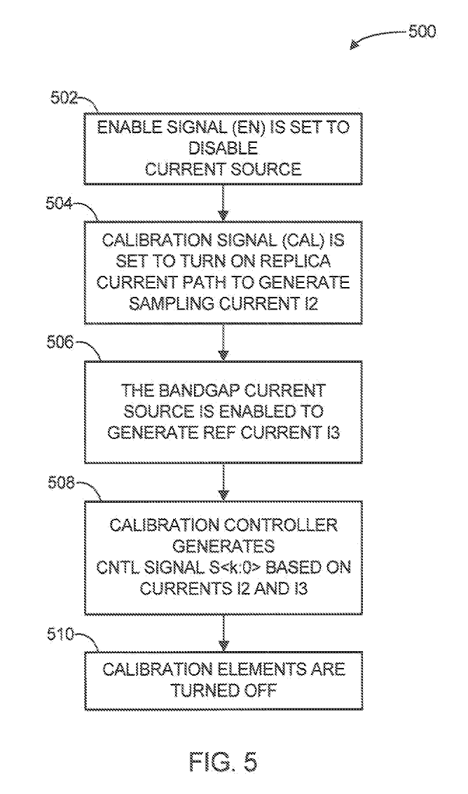

With reference to both FIGS. 4-5, the calibration of the current I1 is as follows. The enable signal (EN) is set to turn off device M0 to effectively disable the current source 404 by not coupling the impedance element 402 to the current source 404 (block 502). This may be done so that a current calibration procedure is performed when the output signal is not being generated. The calibration enable signal (CAL) is also set to turn on device M1 to apply the bias voltage Vbias to the enable inputs of the replica current path devices M2 and M3 (block 504). This causes the replica current path devices to generate the current I2. The bandgap current source 408 is also enabled in order to generate the reference current I3 (block 506). The current calibration controller 406 then generates a current control signal S<k:0> based on the currents I2 and I3 (block 508). As an example, the current calibration controller 406 may be configured as a comparator to adjust the control signal S<k:0> until both currents I2 and I3 are substantially equal. Once the control signal S<k:0> has been set, the calibration devices M1-M3, bandgap current source 408, and current calibration controller may be disabled and/or placed in a low power consumption mode (block 510).

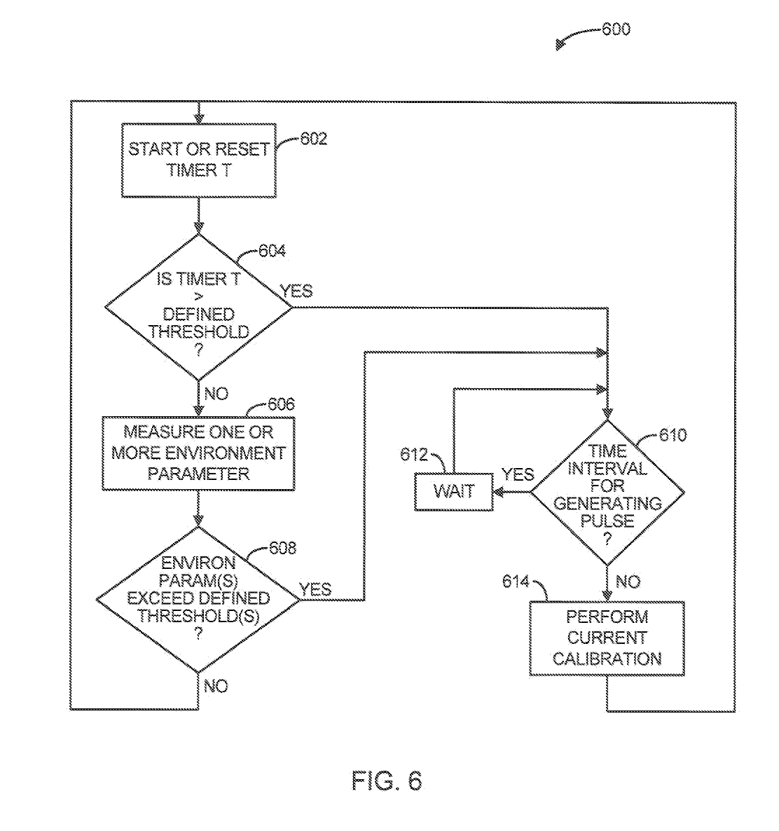

FIG. 6 illustrates a flow diagram of another exemplary method 600 of calibrating the power of a pulse signal generator in accordance with another aspect of the disclosure. The method 600 provides examples of when to perform a current calibration procedure. According to the method 600, a timer is initiated or reset in order to schedule a time to perform a calibration of the pulse generator current (block 602). In block 604, it is determined whether the indicated time T is greater than a defined threshold (block 604). If the answer is no, which may mean that it is not ripe yet for a new calibration procedure, a measurement of one or more environment parameters (e.g., temperature, power supply voltage Vdd, PRF, signal amplitude requirement, etc.) is taken (block 606). It is then determined whether any of the environment parameters exceeded a corresponding defined threshold (block 608). If the answer is no, which may mean that the environment has not changed significantly that would warrant another calibration of the current, the method 600 returns back to block 602.

If the answer is in the affirmative in block 604 or 608, then it may be ripe to perform a current calibration procedure. Before the calibration procedure is commenced, it is determined whether the pulse generator is generating or going to generate a signal (block 610). It would be undesirable to perform a current calibration procedure during the time around the transmission of a pulse signal. If the answer is yes, the calibration procedure is postponed until the transmission of the pulse signal is complete (block 612). If the answer is no, then a current calibration procedure is performed (block 614). Thereafter, the method 600 returns to block 602 to reset the timer again, and begin a new cycle for the subsequent calibration of the pulse generator current.

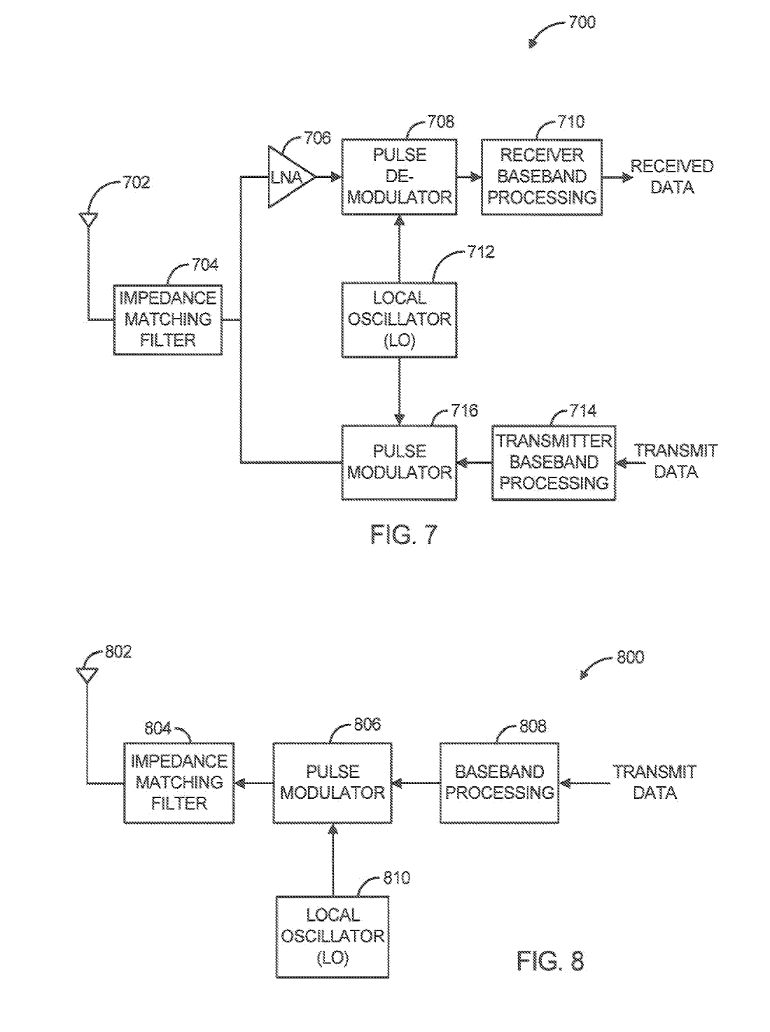

FIG. 7 illustrates a block diagram of an exemplary communication device 700 in accordance with another aspect of the disclosure. The communication device 700 may be one exemplary implementation of a communication device that uses any of the apparatuses previously discussed that generates a signal (e.g., a defined pulse) for transmission to a remote communication device. In particular, the communication device 700 comprises an antenna 702, an impedance matching filter, a low noise amplifier (LNA) 706, a pulse demodulator 708, a receiver baseband processing module 710, a local oscillator (LO) 712, a transmitter baseband processing module 714, and a pulse generator (modulator) 716. As previously discussed, the pulse generator (modulator) 716 may be configured to include any of the apparatuses previously described that generates an output signal (e.g., a defined pulse).

As a source communication device, data to be transmitted to a destination communication device is sent to the transmitter baseband processing module 714. The transmitter baseband processing module 718 processes the transmit data to generate an outgoing baseband signal. The pulse modulator 716, using a signal generated by the local oscillator (LO) 712, processes the outgoing baseband signal to generate an RF signal, which is provided to the antenna 702 via the impedance matching filter 704 for transmission into a wireless medium. The transmit data may be generated by a sensor, a microprocessor, a microcontroller, a RISC processor, a keyboard, a pointing device such as a mouse or a track ball, an audio device, such as a headset, including a transducer such as a microphone, a medical device, a shoe, a robotic or mechanical device that generates data, a user interface, such as a touch-sensitive display, a user device etc. As an example, a user device may be a watch worn to display at least one of the following indications: (1) how fast you're running based on its communication with a sensor in one's shoes; (2) how far you have run; or (3) one's heart rate based on its communication with a sensor attached to one's body. Alternatively, instead of a watch, the user device may be mounted on a bicycle to display such indications.

As a destination communication device, an RF signal carrying data is picked up by the antenna 702 and applied to the LNA 706 via the impedance matching filter 704. The LNA 706 amplifies the received RF signal. The pulse demodulator 708, using a signal generated by the local oscillator (LO) 712, processes the received RF signal to generate a received baseband signal. The receiver baseband processing 710 processes the received baseband signal to produce the received data. A data processor (not shown) may then perform one or more defined operations based on the received data. For example, the data processor may include a microprocessor, a microcontroller, a reduced instruction set computer (RISC) processor, a display, an audio device such as a headset including a transducer such as speakers, a medical device, a watch, a shoe, a robotic or mechanical device responsive to the data, a user interface, such as a display, one or more light emitting diodes (LED), a user device, etc.

FIG. 8 illustrates a block diagram of an exemplary communication device 800 in accordance with another aspect of the disclosure. The communication device 800 may be one exemplary implementation of a communication device that uses any of the apparatuses previously discussed to generate a defined signal (e.g., a defined pulse). In particular, the communication device 800 comprises an antenna 802, an impedance matching filter 804, a pulse generator (modulator) 806, a local oscillator (LO) 810, and a baseband processing module 808. The pulse generator (modulator) 806 may be configured to include any of the apparatuses previously described that generates an output signal (e.g., a defined pulse).

In operation, data to be transmitted to a destination communication device is sent to the baseband processing module 808. The baseband processing module 808 processes the transmit data to generate a baseband signal. The pulse modulator 806, using a signal generated by the local oscillator (LO) 810, processes the baseband signal to generate an RF signal, which provides it to the antenna 802 via the impedance matching filter 804 for transmission into a wireless medium. The transmit data may be generated by a sensor, a microprocessor, a microcontroller, a RISC processor, a keyboard, a pointing device such as a mouse or a track ball, an audio device, such as a headset, including a transducer such as a microphone, a medical device, a shoe, a robotic or mechanical device that generates data, a user interface, such as a touch-sensitive display, a user device, etc.

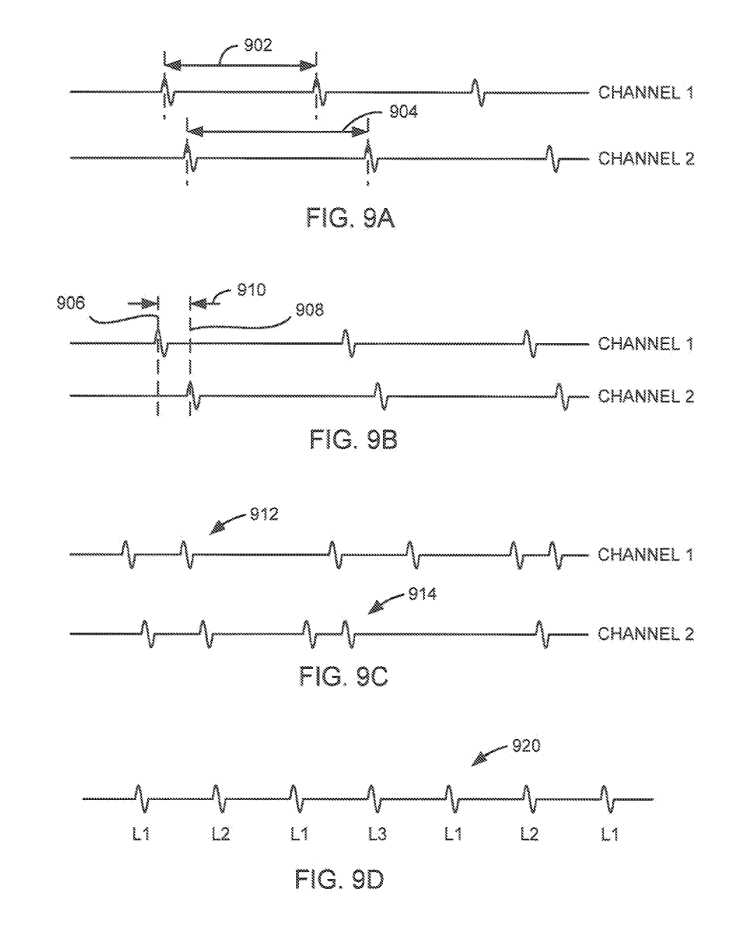

FIG. 9A illustrates different channels (channels 1 and 2) defined with different pulse repetition frequencies (PRF) as an example of a pulse modulation that may be employed in any of the communications systems, devices, and apparatuses described herein. Specifically, pulses for channel 1 have a pulse repetition frequency (PRF) corresponding to a pulse-to-pulse delay period 902. Conversely, pulses for channel 2 have a pulse repetition frequency (PRF) corresponding to a pulse-to-pulse delay period 904. This technique may thus be used to define pseudo-orthogonal channels with a relatively low likelihood of pulse collisions between the two channels. In particular, a low likelihood of pulse collisions may be achieved through the use of a low duty cycle for the pulses. For example, through appropriate selection of the pulse repetition frequencies (PRF), substantially all pulses for a given channel may be transmitted at different times than pulses for any other channel.

The pulse repetition frequency (PRF) defined for a given channel may depend on the data rate or rates supported by that channel. For example, a channel supporting very low data rates (e.g., on the order of a few kilobits per second or Kbps) may employ a corresponding low pulse repetition frequency (PRF)). Conversely, a channel supporting relatively high data rates (e.g., on the order of a several megabits per second or Mbps) may employ a correspondingly higher pulse repetition frequency (PRF).

FIG. 9B illustrates different channels (channels 1 and 2) defined with different pulse positions or offsets as an example of a modulation that may be employed in any of the communications systems described herein. Pulses for channel 1 are generated at a point in time as represented by line 906 in accordance with a first pulse offset (e.g., with respect to a given point in time, not shown). Conversely, pulses for channel 2 are generated at a point in time as represented by line 908 in accordance with a second pulse offset. Given the pulse offset difference between the pulses (as represented by the arrows 910), this technique may be used to reduce the likelihood of pulse collisions between the two channels. Depending on any other signaling parameters that are defined for the channels (e.g., as discussed herein) and the precision of the timing between the devices (e.g., relative clock drift), the use of different pulse offsets may be used to provide orthogonal or pseudo-orthogonal channels.

FIG. 9C illustrates different channels (channels 1 and 2) defined with different timing hopping sequences modulation that may be employed in any of the communications systems described herein. For example, pulses 912 for channel 1 may be generated at times in accordance with one time hopping sequence while pulses 914 for channel 2 may be generated at times in accordance with another time hopping sequence. Depending on the specific sequences used and the precision of the timing between the devices, this technique may be used to provide orthogonal or pseudo-orthogonal channels. For example, the time hopped pulse positions may not be periodic to reduce the possibility of repeat pulse collisions from neighboring channels.

FIG. 9D illustrates different channels defined with different time slots as an example of a pulse modulation that may be employed in any of the communications systems described herein. Pulses for channel L1 are generated at particular time instances. Similarly, pulses for channel L2 are generated at other time instances. In the same manner, pulse for channel L3 are generated at still other time instances. Generally, the time instances pertaining to the different channels do not coincide or may be orthogonal to reduce or eliminate interference between the various channels.

It should be appreciated that other techniques may be used to define channels in accordance with other pulse modulation schemes. For example, a channel may be defined based on different spreading pseudo-random number sequences, or some other suitable parameter or parameters. Moreover, a channel may be defined based on a combination of two or more parameters.

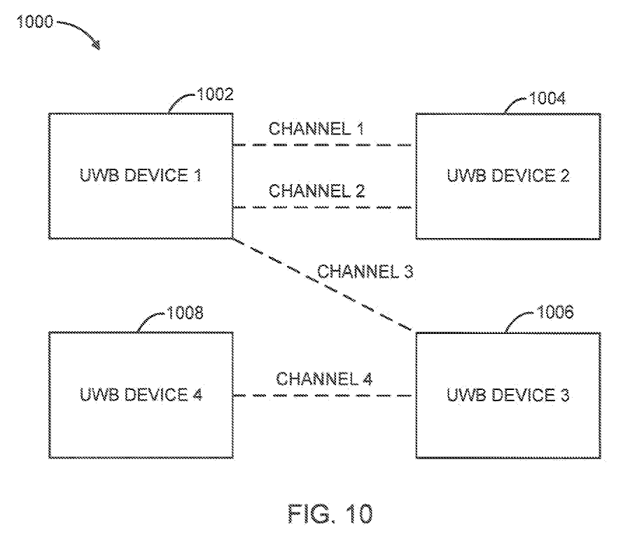

FIG. 10 illustrates a block diagram of various ultra-wide band (UWB) communications devices communicating with each other via various channels in accordance with another aspect of the disclosure. For example, UWB device 1 1002 is communicating with UWB device 2 1004 via two concurrent UWB channels 1 and 2. UWB device 1002 is communicating with UWB device 3 1006 via a single channel 3. And, UWB device 3 1006 is, in turn, communicating with UWB device 4 1008 via a single channel 4. Other configurations are possible. The communications devices may be used for many different applications, and may be implemented, for example, in a headset, microphone, biometric sensor, heart rate monitor, pedometer, EKG device, watch, shoe, remote control, switch, tire pressure monitor, or other communications devices. A medical device may include smart band-aid, sensors, vital sign monitors, and others. The communications devices described herein may be used in any type of sensing application, such as for sensing automotive, athletic, and physiological (medical) responses.

Any of the above aspects of the disclosure may be implemented in many different devices. For example, in addition to medical applications as discussed above, the aspects of the disclosure may be applied to health and fitness applications. Additionally, the aspects of the disclosure may be implemented in shoes for different types of applications. There are other multitude of applications that may incorporate any aspect of the disclosure as described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using another structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. An apparatus for generating a first signal, comprising:
a current source adapted to generate a first current to produce the first signal;
a current sampling module adapted to generate a second current as a function of the first current;
a reference current module adapted to generate a third current; and
a calibration module adapted to calibrate the first current based on the second and third currents.

2. The apparatus of claim 1, wherein the second current is substantially proportional or equal to the first current.

3. The apparatus of claim 1, wherein the reference current module comprises a bandgap current source.

4. The apparatus of claim 1, wherein the current source comprises a plurality of selectable current paths.

5. The apparatus of claim 4, wherein the current sampling module comprises a replica of at least a portion of one or more current paths of the current source.

6. The apparatus of claim 4, wherein the selectable current paths are adapted to produce binary-weighted currents.

7. The apparatus of claim 1, wherein the first current is based on a second signal that defines an amplitude of the first current and a third signal that defines the timing of an amplitude change of the first current.

8. The apparatus of claim 1, further comprising an impedance element through which the first current flows to generate the first signal.

9. The apparatus of claim 1, wherein the first signal comprises a defined pulse.

10. The apparatus of claim 1, wherein the calibration module is adapted to calibrate the first current of the current source based on a defined time, a defined environment parameter, or the first signal not being generated.

11. The apparatus of claim 10, wherein the defined environment parameter comprises an environment temperature, a power supply voltage, a pulse repetition frequency (PRF), or a change in a pulse amplitude requirement.

12. A method of generating a first signal, comprising:
generating a first current to produce the first signal;
generating a second current as a function of the first current;
generating a third current; and
calibrating the first current based on the second and third currents.

13. The method of claim 12, wherein the second current is substantially proportional or equal to the first current.

14. The method of claim 12, wherein generating the third current comprises generating a bandgap reference current.

15. The method of claim 12, wherein generating the first current comprises generating one or more currents through a plurality of selectable current paths, respectively.

16. The method of claim 15, wherein generating the second current comprises activating a replica current path coupled to at least a portion of one or more of the current paths.

17. The method of claim 15, wherein generating the first current comprises generating binary-weighted currents through the selectable current paths, respectively.

18. The method of claim 12, wherein generating the first current comprises generating the first current based on a second signal that defines an amplitude of the first current and a third signal that defines the timing of an amplitude change of the first current.

19. The method of claim 12, further comprising applying the first current through an impedance element to generate the first signal.

20. The method of claim 12, wherein generating the first signal comprises generating a defined pulse.

21. The method of claim 12, wherein calibrating the first current comprises calibrating the first current based on a defined time, a defined environment parameter, or the first signal not being generated.

22. The method of claim 21, wherein the defined environment parameter comprises an environment temperature, a power supply voltage, a pulse repetition frequency (PRF), or a change in a pulse amplitude requirement.

23. An apparatus for generating a first signal, comprising:
means for generating a first current to produce the first signal;
means for generating a second current as a function of the first current;
means for generating a third current; and
means for calibrating the first current based on the second and third currents.

24. The apparatus of claim 23, wherein the second current is substantially proportional or equal to the first current.

25. The apparatus of claim 23, wherein third current generating means comprises means for generating a bandgap reference current.

26. The apparatus of claim 23, wherein first current generating means comprises means for generating one or more of a plurality of selectable currents.

27. The apparatus of claim 26, wherein second current generating means comprises means for generating a replica of one or more of the selectable currents.

28. The apparatus of claim 26, wherein means for generating one or more of the plurality of selectable currents comprises means for generating one or more binary-weighted currents.

29. The apparatus of claim 23, wherein the first current generating means is adapted to generate the first current based on a second signal that defines an amplitude of the first current and a third signal that defines the timing of an amplitude change of the first current.

30. The apparatus of claim 23, further comprising means for generating an impedance through which the first current flows to generate the first signal.

31. The apparatus of claim 23, wherein the first signal comprises a defined pulse.

32. The apparatus of claim 23, wherein calibrating means comprises means for calibrating the first current based on a defined time, a defined environment parameter, or the first signal not being generated.

33. The apparatus of claim 32, wherein the defined environment parameter comprises an environment temperature, a power supply voltage, a pulse repetition frequency (PRF), or a change in a pulse amplitude requirement.

34. A computer program product, comprising:
a computer readable medium comprising instructions executable to:
generate a first current to produce a first signal;
generate a second current as a function of the first current;
generate a third current; and
calibrate the first current based on the second and third currents.

35. A headset, comprising:
a transducer adapted to generate audio data; and
a transmitter adapted to transmit a first signal comprising the audio data, wherein the transmitter comprises:
a current source adapted to generate a first current to produce the first signal;
a current sampling module adapted to generate a second current as a function of the first current;
a reference current module adapted to generate a third current; and
a calibration module adapted to calibrate the first current based on the second and third currents.

36. A user device, comprising:
a user interface; and
a transmitter adapted to transmit a first signal comprising data received from the user interface, wherein the transmitter comprises:
a current source adapted to generate a first current to produce the first signal;
a current sampling module adapted to generate a second current as a function of the first current;
a reference current module adapted to generate a third current; and
a calibration module adapted to calibrate the first current based on the second and third currents.

37. A sensing device, comprising:
a sensor adapted to generate sensed data; and
a transmitter adapted to transmit a first signal comprising the sensed data, wherein the transmitter comprises:
a current source adapted to generate a first current to produce the first signal;
a current sampling module adapted to generate a second current as a function of the first current;
a reference current module adapted to generate a third current; and
a calibration module adapted to calibrate the first current based on the second and third currents.
